(19) United States
(12) Patent Application Publication
(10) Pub. No.: US 2004/0256475 A1
(43) Pub. Date: Dec. 23, 2004

(54) Thermostat lip seal

(76) Inventor: Neil Henige, Gaines, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/870,559

(22) Filed: Jun. 17, 2004

Related U.S. Application Data
(60) Provisional application No. 60/480,139, filed on Jun. 20, 2003.

(51) Int. Cl. G05D 23/02

(52) U.S. Cl. 236/101 R

(57) ABSTRACT

A thermostat housing assembly includes al seal that seals between the housing and a mounting surface and the between the thermostat and the housing. The housing defines a passage and a flange for mounting the housing to the mounting surface. The seal is attached to the housing within a first annular recess. The seal overlaps a portion of the thermostat disposed within a second annular recess. The portion of the seal that overlaps the thermostat seals the thermostat against the mounting surface. The seal also includes a lead in surface on a radially inward portion. The lead in surface provides for assembly of the thermostat to the housing and holds the thermostat within the housing prior to assembly to the mounting surface.

The application claims priority to U.S. Provisional Application No. 60/480,139, which was filed on Jun. 20, 2003.

### BACKGROUND OF THE INVENTION

This invention generally relates to a thermostat housing assembly, and specifically to a thermostat housing assembly including a seal for sealing between the housing and an engine block and between the thermostat and the housing.

Current thermostat assemblies include a thermostat valve with a spring biasing a valve member toward a closed position and an expandable member expandable in response to heat that opens the valve member to regulate fluid flow. A thermostat housing assembly is typically installed to an engine block of a vehicle to regulate coolant flow. A seal or gasket is provided to prevent fluid leakage between the thermostat housing and the engine block. Another seal is provided to prevent fluid leakage around the thermostat within the thermostat housing.

Typically, the thermostat housing is fabricated from metal or plastic and requires a separately installed gasket that seals against the engine block. The thermostat requires another seal to prevent leakage around the thermostat. Improvements to the conventional thermostat housing assembly include the over molding of a seal directly to the thermostat to eliminate the need for a separately installed seal between the thermostat and the thermostat housing. Typically, over-molding of a seal includes inserting the thermostat into a mold and injecting seal material onto a flange of the thermostat. The thermostat is exposed to elevated temperatures during the over-molding process that may damage the thermostat.

Accordingly, it is desirable to design a thermostat housing assembly with a reduced number of components that seals to prevent leakage between the thermostat housing, thermostat and engine block.

### SUMMARY OF THE INVENTION

This invention is a thermostat housing assembly that includes an integral seal that provides both the seal between the housing and the mounting surface and the seal between the valve and the mounting surface.

The thermostat housing assembly includes a housing defining a fluid flow passage and a flange for mounting the housing to a mounting surface. A seal is attached to the housing within a first annular recess. The seal overlaps a portion of a second annular recess supporting the valve. The valve includes a valve flange that is partially overlapped by a portion of the seal. The portion of the seal that overlaps the valve flange seals the valve flange against the mounting surface.

The seal also includes a lead in surface on a radially inward portion. The lead in surface provides for assembly of the valve to the housing. The seal overlap holds the valve within the housing prior to assembly to the mounting surface. The thermostat remains within the housing during shipping, assembly and disassembly of the thermostat housing.

Accordingly, the thermostat housing assembly of this invention provides a reduced number of components and provides one seal that seals the housing and valve to the mounting surface and that holds the valve within the housing prior to assembly.

These and other features of the present invention can be best understood from the following specification and drawings, the following of which is a brief description.

### BRIEF DESCRIPTION OF THE DRAWINGS

FIG. 1 is a perspective view of a thermostat housing including a thermostat and a seal.

FIG. 2 is an enlarged cross-sectional view of the thermostat housing prior to installation.

FIG. 3 is an enlarged cross-sectional view of the thermostat housing installed.

### DETAILED DESCRIPTION OF THE PREFERRED EMBODIMENT

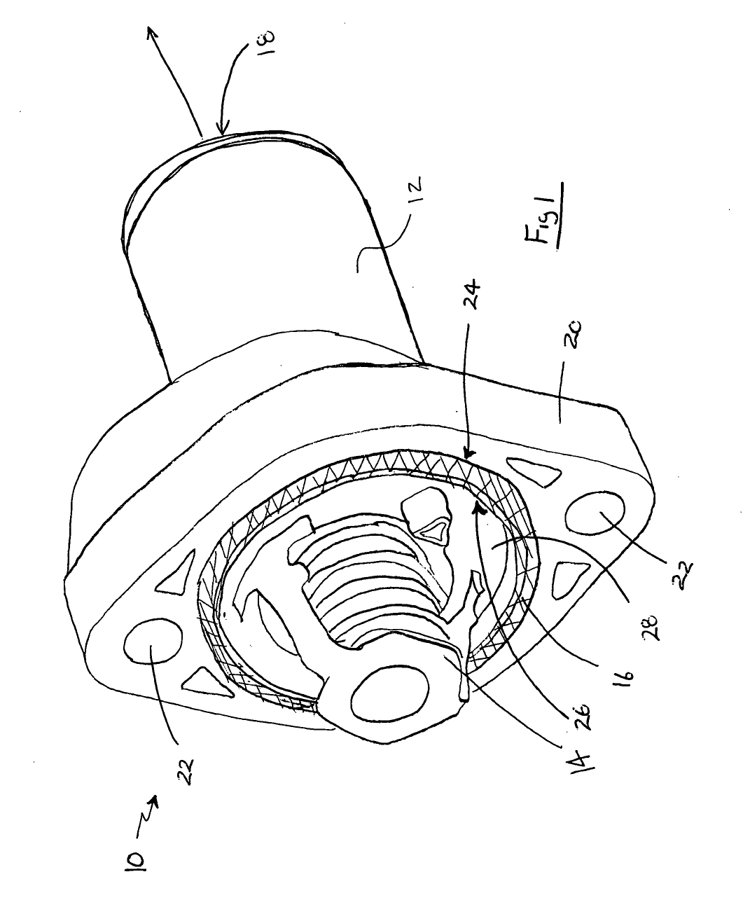

Referring to FIG. 1, a thermostat housing assembly 10 includes a thermostat 14 secured within a housing 12 by a seal 16. The housing 12 defines a fluid flow passage 18 for coolant to an engine of a motor vehicle. The thermostat 14 is responsive to heat to regulate fluid flow through the flow passage 18.

The housing 12 includes a flange portion 20 having openings 22 for fastening members. The seal 16 is disposed at a shoulder 24, and forms a lip 26 that extends inward from the shoulder 24 to trap the thermostat 14 within the housing 12. A flange 28 of the thermostat 14 is trapped and held within the housing 12 until assembly.

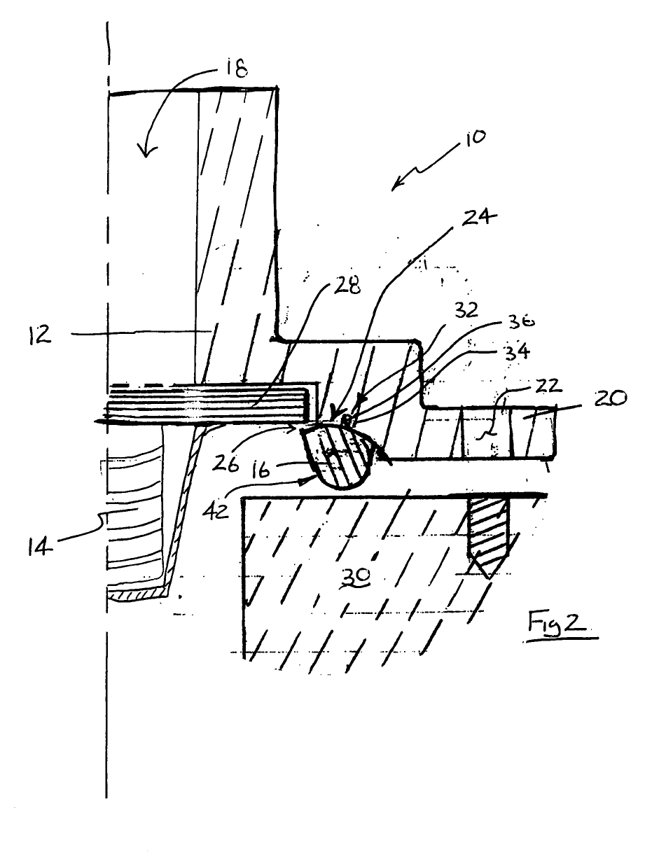

Referring to FIG. 2, the seal 16 is molded to a shoulder 24 of the flange 20 of the housing 12. The seal 16 is a generally spherical shape and includes the lip 26 that extends radially inwardly from the shoulder 24. The lip 26 traps the flange 28 of the thermostat 14 within the housing 12 prior to assembly to engine block 30. The seal 16 is attached to the housing 12 during a molding process such that no hand assembly of the seal 16 to the housing 12 is required. The seal 16 remains in place and holds the thermostat 14 within the housing 12. The seal 16 includes an attachment feature 32 that secures the seal 16 to the housing 12. The attachment feature 32 comprises a slot 34 formed within the housing 12, and a tab 36 that fills the slot 34.

The seal 16 includes a lead in surface 42. The lead in surface 42 provides for assembly of the thermostat 14 into the housing 12. Once the housing 12 and seal 16 are formed, the thermostat 14 is pushed into the housing 12. The lead in surface 42 guides the thermostat 14 past the seal 16. The seal 16 is pliable and compresses sufficiently to allow the thermostat 14 to pass. The lip 26 then retracts and substantially prevents the thermostat 14 from separating from the housing 12 during normal handling. Because the thermostat 14 is secured within the housing 12, and the seal 16 is secured to the housing 12, no special handling or packaging is required for the thermostat housing assembly 10.

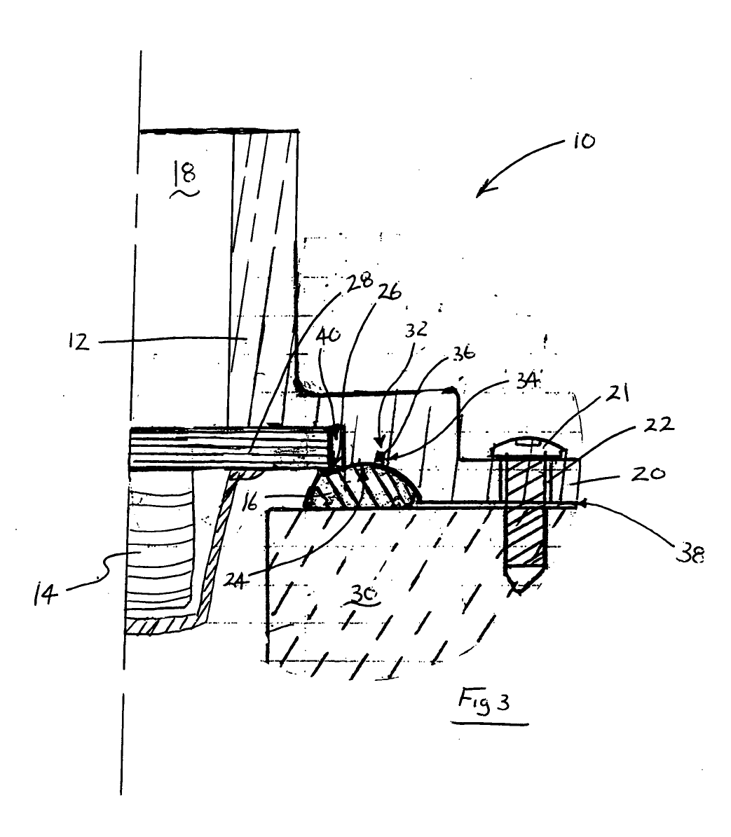

Referring to FIG. 3, the thermostat housing assembly 10 is shown secured to the engine block 30. Fastening member 21 secures the housing 12 to the engine block 30 and force deformation of the seal 16. Deformation of the seal 16 spreads the lip 26 over the flange 28 of the thermostat 14 to seal against leakage around the thermostat 14 and between the housing 12 and engine block 30.

In the assembled position, there are two potential leak paths for fluid flowing through the housing 12 and thermostat 14. A first potential leak path 38 between the housing 12 and the engine block 30. A second potential leak path 40 is between the thermostat 14 and the housing 12. The seal 16 flattens out during installation to the engine block 30 to overlap the flange 28 of the thermostat 14 and seal the first leak path 38. Further, pressure during assembly spreads the seal 24 over the flange 28 to seal the second leak path 40.

Preferably, the seal 16 is integrally formed within the housing 12 in a two step molding process. A mold forms the housing shape from a first material that hardens to form the desired shape of the housing 12. A second material is then introduced to form the seal 16. The seal material differs from the first material forming the rigid housing shape. The seal material remains pliable after curing to provide a seal between the housing 12 and the engine block 30. As appreciated, material selection for the seal 16 and housing 12 is application specific and a worker skilled in the art would understand the parameters dictating the selection of material.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A thermostat housing assembly comprising:
a housing including a passage and a flange for mounting to a mounting surface;
a valve regulating flow through said passage; and
a seal for sealing between said flange and the mounting surface and between said valve and said housing.

2. The assembly as recited in claim 1, wherein said flange comprises a first annular recess for mounting said seal and a second annular recess radially inward from said first annular recess for mounting said valve.

3. The assembly as recited in claim 2, wherein said seal includes a lip extending radially inwardly between said first and second annular recesses.

4. The assembly as recited in claim 3, wherein said valve includes a valve flange and said lip extends radially inward from said first annular recess to overlap said valve flange.

5. The assembly as recited in claim 4, wherein said lip overlapping said valve flange holds said valve within said housing.

6. The assembly as recited in claim 2, wherein said first annular recess comprises a radial surface.

7. The assembly as recited in claim 1, wherein said seal comprises an attachment member cooperating with an attachment feature within said housing for securing said seal to said housing.

8. The assembly as recited in claim 7, wherein said attachment feature within said housing comprises a slot, and said attachment member comprises a tab secured within said slot.

9. The assembly as recited in claim 1, wherein said seal comprises a lead in surface on an radially inward portion for providing installation of said valve into said housing.

10. The assembly as recited in claim 1, wherein said seal comprises a substantially spherical shape.

11. The assembly as recited in claim 1, wherein said flange comprises a sealing surface abutting said mounting surface wherein said seal extends beyond a plane defined by said sealing surface when in an uninstalled condition.

12. The assembly as recited in claim 1, wherein said housing comprises a plastic material.

13. The assembly as recited in claim 11, wherein said seal comprises a pliable material molded into said housing.

14. A thermostat housing assembly comprising:
a housing including a passage and a flange for mounting to a mounting surface;
a valve regulating flow through said passage; and
a seal attached to said housing, said seal providing a seal between said housing and the mounting surface and between said valve and said housing.

15. The assembly as recited in claim 14, wherein said flange comprises a first recess for said seal and a second recess for said valve.

16. The assembly as recited in claim 14, wherein said valve includes a valve flange, said seal extending radially inward of an outer periphery of said valve flange.

17. The assembly as recited in claim 16, wherein said seal includes a lead in surface on a radially inward side, said valve flange movable along said lead in surface for moving past said seal.

18. The assembly as recited in claim 14, wherein said seal is substantially spherically shaped.
